(19) United States
(12) Patent Application Publication
(10) Pub. No.: US 2026/0007955 A1
(43) Pub. Date: Jan. 8, 2026

(54) GAME CONTROLLER WITH ACCESSIBLE VIRTUAL ASSISTANT

(71) Applicant: ACCO BRANDS CORPORATION, Lake Zurich, IL (US)

(72) Inventor: Adam NOCE, Lake Zurich, IL (US)

(73) Assignee: ACCO BRANDS CORPORATION, Lake Zurich, IL (US)

(21) Appl. No.: 19/254,142

(22) Filed: Jun. 30, 2025

Related U.S. Application Data
(60) Provisional application No. 63/666,872, filed on Jul. 2, 2024.

(51) Int. Cl. A63F 13/24

(52) U.S. Cl. CPC A63F 13/24

(57) ABSTRACT

A game controller includes gameplaying controls, at least one input device for providing information to a virtual assistant (artificial intelligence assistant), and at least one output device for providing output from the virtual assistant. The virtual assistant may use artificial intelligence to provide information to a user of the game controller, for example information relating to the game being played, such as gameplaying hints, game information, or background information regarding persons, events, and/or objects in the game. Example input devices include a camera and a microphone, and an example output device includes a speaker for providing verbal information or nonverbal sounds to the user.

### RELATED APPLICATIONS

This application claims priority to U.S. Provisional Patent Application Ser. No. 63/666,872, filed Jul. 2, 2024, titled GAME CONTROLLER WITH ACCESSIBLE VIRTUAL ASSISTANT, the entire disclosure of which is incorporated by reference herein.

### FIELD OF INVENTION

The present invention relates to video games, in particular to assistance for users playing video games.

### BACKGROUND

Video game controllers allow users to play computer games. Yet games are increasingly involved, complex, and/or difficult to play and/or master. At least some computer game users would appreciate assistance in and/or during gameplay.

### SUMMARY OF THE INVENTION

A game controller may include a virtual assistant that uses artificial intelligence, and is able to respond to user inquiries, and/or to assist a user with one or more gameplay and/or non-gameplay actions.

According to an aspect, a video game controller includes: a controller body; at least one game control input including at least one analog stick, at least two trigger buttons, at least one action button, and at least one directional pad operatively installed to the controller body; and at least one input device operatively installed to the controller body and configured to invoke artificial intelligence assistance.

In an embodiment, the game controller includes at least one input device for providing input to the artificial intelligence assistance.

In an embodiment, the at least one input device includes a microphone.

In an embodiment, the artificial intelligence assistance is configured to be invoked by a predetermined sound caught by the at least one input device.

In an embodiment, the at least one input device includes an image sensor or camera.

In an embodiment, the artificial intelligence assistance is configured to receive input from the image sensor or camera and to detect a specific game being played based on the input.

In an embodiment, the artificial intelligence assistance is configured to receive input from the image sensor or camera and to detect level or section within a specific game being played based on the input.

In an embodiment, the artificial intelligence assistance is configured to receive input from the image sensor or camera and to detect level or section within a specific game being played based on the input and to provide output corresponding to a strategy or tips for completing or exiting the level or section.

In an embodiment, the artificial intelligence assistance is configured to receive input from the image sensor or camera and to detect a specific game being played based on the input and to provide output corresponding to the specific game.

In an embodiment, the artificial intelligence assistance is configured to receive input from the image sensor or camera and to detect a specific game being played based on the input and to provide output corresponding to the specific game when prompted by a user's voice command.

In an embodiment, the artificial intelligence assistance is configured to receive input from the image sensor or camera and to use the received input to train the artificial intelligence assistance.

In an embodiment, the artificial intelligence assistance is configured to receive input and to provide output corresponding to the specific game being played including strategy or tips for succeeding in the game.

In an embodiment, the artificial intelligence assistance is configured to receive input corresponding to the at least one game control input and use the received input to train the artificial intelligence assistance.

In an embodiment, the artificial intelligence assistance is configured to receive game input from the microphone and to detect a specific game being played based on the game input.

In an embodiment, the artificial intelligence assistance is configured to receive game input from the microphone and to detect level or section within a specific game being played based on the input.

In an embodiment, the artificial intelligence assistance is configured to receive input from the microphone and to detect level or section within a specific game being played based on the input and to provide output corresponding to a strategy or tips for completing or exiting the level or section.

In an embodiment, the artificial intelligence assistance is configured to receive input from the microphone and to detect a specific game being played based on the input and to provide output corresponding to the specific game.

In an embodiment, the artificial intelligence assistance is configured to receive input from the microphone and to detect a specific game being played based on the input and to provide output corresponding to the specific game when prompted by a user's voice command.

In an embodiment, the artificial intelligence assistance is configured to receive input from the microphone and to use the received input to train the artificial intelligence assistance.

In an embodiment, the artificial intelligence assistance is configured to: receive a user voice command via the microphone; parse the user voice command using natural language processing techniques to identify an in-game action; and execute inputs with respect to a specific game to perform the identified in-game action.

In an embodiment, the game controller further includes at least one output device for providing output from the artificial intelligence assistance.

In an embodiment, the at least one output device includes a speaker.

According to another aspect, a method of assisting a video game controller user includes: receiving data on video game gameplay; processing the data to produce an artificial intelligence virtual gameplay assistant; receiving user input from a video game user; and using the virtual gameplay assistant to produce a response to the user input.

In one embodiment, the virtual assistant may include artificial intelligence capabilities.

In one embodiment, the virtual assistant may use a large language model, such as by being trained on the large language model.

In one embodiment, the large language model may include training with content focused on, or exclusively including, video game content (or video-game-related content).

In one embodiment, the game controller may include game playing controls, for example buttons or joysticks, for interacting with a video game. The controls may be embedded in a housing of the controller.

In one embodiment, the game controller may include at least one input device for providing input to (or input to be used by) the virtual assistant.

In one embodiment, the at least one input device may include a microphone.

In one embodiment, the microphone may be activatable by a switch (such as a button) that is on the game controller.

In one embodiment, the microphone may be configured to be activated upon detection of a predetermined sound, for example a word that is used by the user to trigger interaction with the virtual assistant.

In one embodiment, the microphone may be configured to allow the user to direct the virtual assistant using commands and/or interactions utilizing natural language.

In one embodiment, the virtual assistant may be configured to parse and interpret natural language input spoken by the user.

In one embodiment, the game controller may include wireless communication capability.

In one embodiment, the wireless communication capability may include Wi-Fi capability.

In one embodiment, the wireless communication capability may allow communication with a server (or more generally with one or more computers, such as including cloud computing) for receiving inputs from the game controller and/or user, doing processing associated with the virtual assistant, and sending output from the virtual assistant back to the game controller.

In one embodiment, the at least one input device may include a camera or other image sensor.

In one embodiment, the camera or other image sensor may be configured to obtain information from viewing the screen of a game that is being played by the user.

In one embodiment, the camera or other image sensor may be configured to determine from one or more views the game that is being played by the user.

In one embodiment, the camera or other image sensor may be configured to receive mapping information that may be stored and accessed by the virtual assistant.

In one embodiment, the virtual assistant may be configured to provide gameplay hints and/or tips to the user based at least in part on information received by the camera or other image sensor.

In one embodiment, the at least one output device may include a speaker, such as to provide sounds or spoken words to provide information from the virtual assistant to the user.

In one embodiment, the game controller may be operatively coupled to a game console.

In one embodiment, the processing for the virtual assistant may be performed at least in part in the game console.

In one embodiment, the virtual assistant may draw information from the game itself (executed in software and/or hardware by the game console).

In one embodiment, the virtual assistant may be configured to “take over” the controller in certain circumstances, such as to show things on a map or to find things in a game menu.

In one embodiment, the virtual assistant may be configured to interact with the controller to provide tactile information to the user, for example activating rumble motors of the controller to communicate one or more game-related events.

In one embodiment, the virtual assistant may be configured to perform tasks not directly related to game play, such as ordering food.

In one embodiment, the virtual assistant may learn map information of the game, such as to provide spoken directions for character movement within the same, for example upon request by the user.

In one embodiment, the virtual assistant may be configured to allow the user to request that it keep track of game-related items. For example, a user may request that the virtual assistant keep track of ammunition, and provide a warning when the supply is running low.

In one embodiment, the virtual assistant may be configured to answer user questions about game play.

In one embodiment, the virtual assistant may be configured to assist the user in changing character appearance, for example being able through natural-language instructions to aid a user in making a character appearance that resembles the appearance of celebrity.

In one embodiment, the virtual assistant may be configured to provide information that is related to the game, but not directly to game play. For example, the virtual assistant may be used by the user to obtain background information on historical figures or events that are part of a game. Other possibilities include geographical information, information regarding vehicles such as cars, and information regarding objects, such as (to give one example) weapons.

In one embodiment, the virtual assistant may record user activities, which may be used to determine optimal (or more optimal) strategies for game play. Information from multiple users may be aggregated in this regard, to provide improved knowledge to and/or performance by the virtual assistant.

The accompanying drawings, which are incorporated in and constitute a part of the specification, illustrate various example systems, methods, and so on, that illustrate various example embodiments of aspects of the invention. It will be appreciated that the illustrated element boundaries (e.g., boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa. Furthermore, elements may not be drawn to scale.

### BRIEF DESCRIPTION OF THE DRAWINGS

FIG. 1 schematically shows a game system, according to an embodiment.

FIG. 2 is an oblique view of a game controller that is part of the game system of FIG. 1.

FIG. 3 is another oblique view of the game controller of FIG. 2.

FIG. 4 is a block diagram of a computing device for performing functions of the virtual assistant of the game system of FIG. 1.

FIG. 5 is schematic view illustrating a first function of the virtual assistant.

FIG. 6 is a schematic view illustrating a second function of the virtual assistant.

FIG. 7 is schematic view illustrating a third function of the virtual assistant.

FIG. 8 is schematic view illustrating a fourth function of the virtual assistant.

FIG. 9 is schematic view illustrating a fifth function of the virtual assistant.

FIG. 10 is a schematic view illustrating a sixth function of the virtual assistant.

FIG. 11 is schematic view illustrating a seventh function of the virtual assistant.

FIG. 12 is a schematic view illustrating an eighth function of the virtual assistant.

FIG. 13 is a high-level flow chart illustrating a method of using the virtual assistant.

### DETAILED DESCRIPTION

A game controller includes gameplaying controls, at least one input device for providing information to a virtual assistant (artificial intelligence assistant), and at least one output device for providing output from the virtual assistant. The virtual assistant may use artificial intelligence to provide information to a user of the game controller, for example information relating to the game being played, such as gameplaying hints, game information, or background information regarding persons, events, and/or objects in the game. Example input devices include a camera and a microphone, and an example output device includes a speaker for providing verbal information or nonverbal sounds to the user.

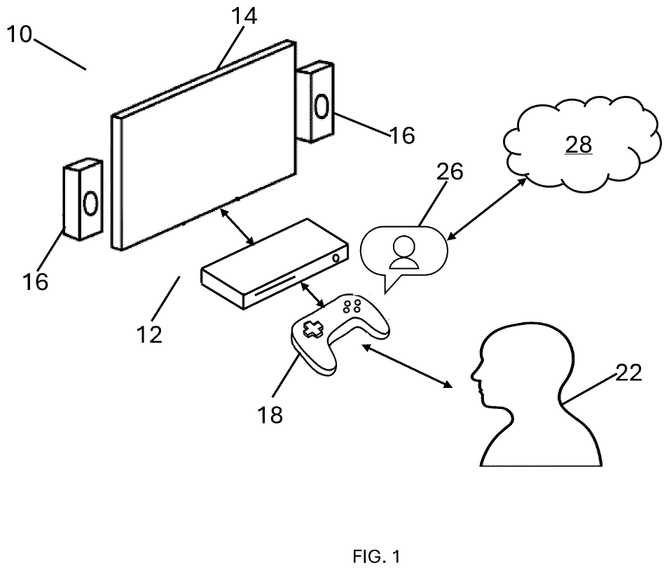

FIG. 1 schematically shows a game system 10 that includes a game console 12, a screen 14, speakers 16, and a game controller 18. A user 22 operates the game controller 18 to play the game. The game controller 18 interacts with the console 12, which in turn provides information to be output on the screen 14 and/or the speakers 16. In brief, during game play the game console 18 provides output to be visually displayed on the screen 14 and/or aural contact played by the speakers 16, and the user 22 reacts to visual and/or aural information by manipulating gameplay controls on the controller 18, which in turn affects what is output by the game console 12.

The game system 10 also includes a virtual assistant 26, an artificial intelligence assistant that receives information and interacts with the user 22, for example to aid the user 22 in gameplay. The virtual assistant 26 uses artificial intelligence in interacting with the user 22. The virtual assistant (artificial intelligence assistant) 26 is not a separate structure, but is embodied in various parts of the system 10. The information-processing of the virtual assistant 26 may be performed in one or more separate processors 28, which may be physically separate from the rest of the game system 10. For example, the processors 28 may be part of a cloud computer, and may be operatively coupled to the console 12 and/or to the controller 18. For example, the controller 18 may be wirelessly coupled, such as through Wi-Fi capability of the game controller 18, to the one or more processors 28.

As described below in greater detail, the virtual assistant 26 may be configured to aid the user 22 during gameplay, with performing tasks within the game, and/or with providing other information and/or performing nongame tasks. The virtual assistant 26 may receive input from the user 22, such as spoken language input, which may be in the form of natural-language commands, questions, or other statements, which may be parsed by the virtual assistant 26. Such input may be received through a microphone or other listening device that may be incorporated in the controller 18.

The virtual assistant 26 may also receive visual input, such as from a view of the screen 14. The visual input may be routed through a camera or other visual sensor that is part of the controller 18. For example, video views of the screen 14 may aid the virtual assistant 26 in mapping the world of the game, and keeping track of the location of the user's avatar or representation withing that game world.

The virtual assistant 26 may provide information to the user in the form of speech or nonverbal sounds. This output may be routed through a speaker that is part of the controller 18.

The functions for the virtual assistant 26 described above are only examples, and many other functions may be performed by the virtual assistant 26. Some of these other functions are described below.

The system 10 may have any of a variety of suitable components and variations for playing any of a variety of suitable games. The screen 14 may be a monitor, television, or other suitable video display. The speakers 16 may be integral parts of the screen 14, or may be separate devices. The connections between the game console 12, and the screen 14 and the controller, are depicted as wireless, but alternatively one or both may be a wired connection.

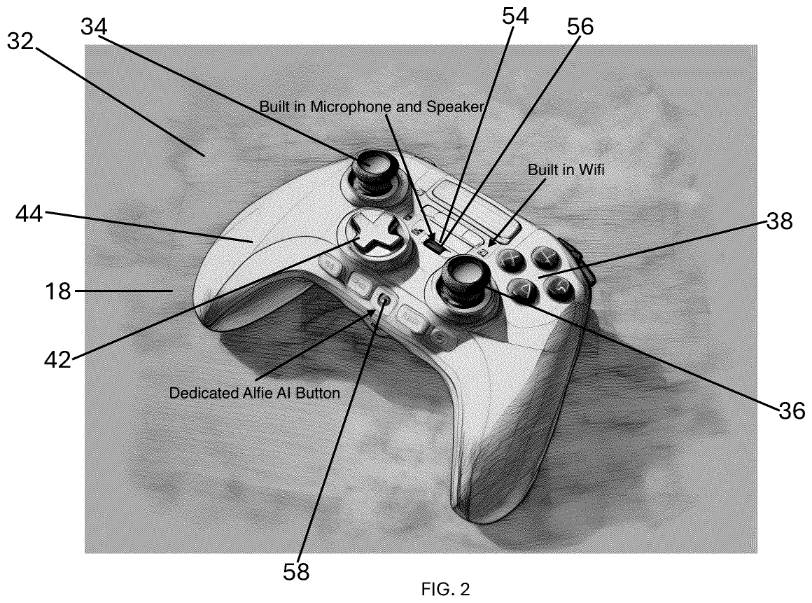

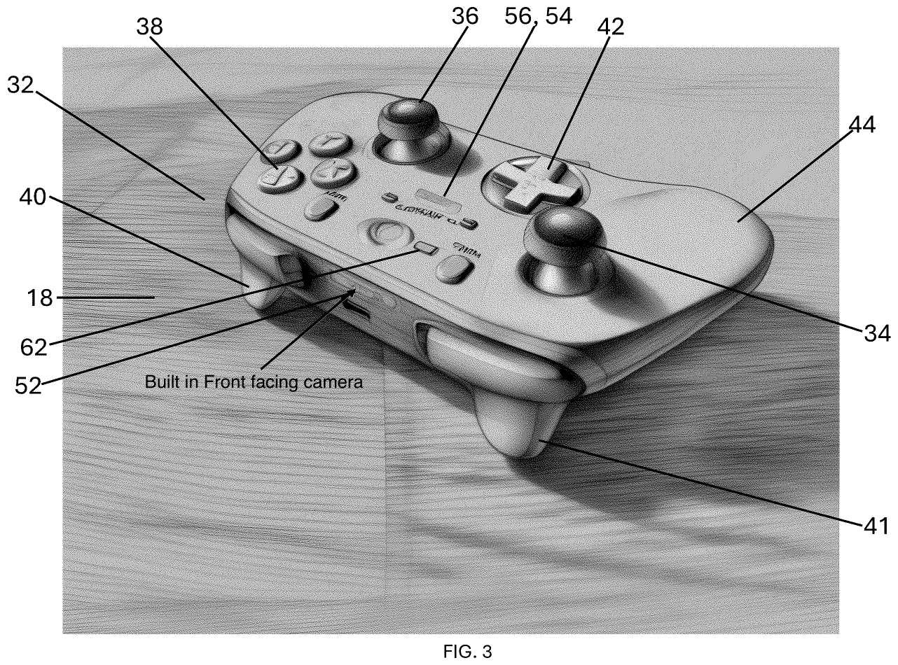

FIGS. 2 and 3 show details of an embodiment of the controller 18. The controller 18 includes gameplay controls (game control inputs) 32 that are manipulated by the user 22 (FIG. 1) in playing a game, such as on the game system 10 (FIG. 1). The gameplay controls 32 in the illustrated embodiment include a pair of analog sticks 34 and 36, a set of action buttons 38, a pair of trigger buttons 40 and 41, and a directional pad 42. These are only one example of possible types and arrangement of the gameplay controls on a body 44 of the controller 18. Many variations in the number, type, and/or arrangement of gameplay controls are possible.

The controller 18 also has further features to gather information for interaction with the virtual assistant 26 (FIG. 1), or to allow interaction between the user 22 (FIG. 1) and the virtual assistant 26. A front-facing camera 52 is built into the body 44 at the front of the controller 18. The camera (or other optical sensor) 52 may be used for gathering visual information, such as from the screen 14 (FIG. 1). Such visual information may be used by the virtual assistant 26.

The controller 18 may also have a controller speaker 54 and a microphone 56. The speaker 54 may be used to provide aural information and/or output to user 22 (FIG. 1), such as in the form of spoken language and/or sound effects. The speaker 54 may be used to provide information from the virtual assistant 26 (FIG. 1) to the user 22. The speaker 54 may also communicate other information, such as gameplay information not from the virtual assistant 26.

The microphone 56 may be used to provide information to the virtual assistant 26 (FIG. 1). For example, the microphone 56 may be used to receive verbal commands to command the virtual assistant 26 to take one or more actions. The verbal commands may be natural-language commands to be parsed by the virtual assistant 26. The verbal commands may use one or more key words to trigger action(s) by the virtual assistant 26. the microphone 56 may also be configured to receive sounds other than from the user 22 (FIG. 1), such as gameplay sounds and/or other environmental sounds.

A switch on the controller 18, such as a button 58, may be used by the user 22 (FIG. 1) to activate the microphone 56 to receive commands or other information from the user 22, to be directed to the virtual assistant 26 (FIG. 1). Alternatively or in addition, the microphone 56 may be activated for communication with the virtual assistant 26 by detecting a predetermined sound, such as by detecting utterance of a predetermined “wake word” (or phrase or sound) by the user 22. The microphone 56 may be active to receive sounds even when not activated to receive commands for communication with the virtual assistant 26. Sounds detected by the microphone 56, whether from the user 22 or from other sources, may be used for other purposes than communication with the virtual assistant 26.

The controller 18 includes a communication device 62, such as an antenna, for wireless communication. The wireless communication may occur between the controller 18 and the external processor(s) 28 (FIG. 1), and/or between the controller 18 and the game console 12 (FIG. 1). The communication device 62 may be used to communicate between the game controller 18 and the virtual assistant 26 (FIG. 1). The wireless communications may be Wi-Fi communications, or may be other types of wireless communications, such as using Bluetooth, cellular phone signals, or other radio frequency signals.

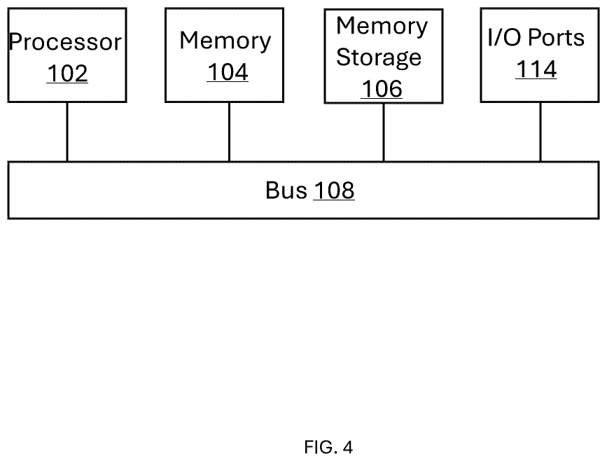

FIG. 4 illustrates a block diagram of an example computing device 100 for performing functions of the virtual assistant 26 (FIG. 1). As discussed above, the functions of the virtual assistant 26 may be performed in one or more external computing devices (represented in FIG. 1 as the one or more processors 28).

The computing device 100 may include a processor 102, a memory 104, and a memory storage 106 operably connected by a bus 108. The computing device may include I/O Ports 114, which may be used to communicate with the other parts of the gaming system 10 (FIG. 1). The handheld game controller 18 (FIG. 1) may transmit user input signals (either from the gameplay controls 32 (FIG. 2) or the microphone 56 (FIG. 2) for input to the computing device 100 through the I/O Ports 114, which may be linked to suitable devices for wirelessly receiving such input signals. The processor 102 may perform some of the functions of the virtual assistant 26 (FIG. 1), examples of which are described elsewhere in this description in greater detail.

The processor 102 can be a variety of various processors including dual microprocessors and other multi-processor architectures. The memory 604 can include volatile memory or non-volatile memory. The non-volatile memory can include, but is not limited to, ROM, PROM, EPROM, EEPROM, and the like. Volatile memory can include, for example, RAM, synchronous RAM (SRAM), dynamic RAM (DRAM), synchronous DRAM (SDRAM), double data rate SDRAM (DDR SDRAM), and direct RAM bus RAM (DRRAM). The storage 106 may be operably connected to the processor 102 via the bus 108. The storage 106 can include, but is not limited to, devices like a magnetic disk drive, a solid-state disk drive, a flash memory card, or a memory stick. The memory 104 can store processes or data. The storage 106 or memory 104 can store an operating system that controls and allocates resources of the computing device 100.

The bus 108 can be a single internal bus interconnect architecture or other bus or mesh architectures. While a single bus is illustrated, it is to be appreciated that components of the device 100 may communicate with various devices, logics, and peripherals using other buses that are not illustrated (e.g., PCIE, SATA, Infiniband, 1394, USB, Ethernet). The bus 108 can be of a variety of types including, but not limited to, a memory bus or memory controller, a peripheral bus or external bus, a crossbar switch, or a local bus. The local bus can be of varieties including, but not limited to, an industrial standard architecture (ISA) bus, a microchannel architecture (MCA) bus, an extended ISA (EISA) bus, a peripheral component interconnect (PCI) bus, a universal serial (USB) bus, and a small computer systems interface (SCSI) bus.

The computing device 100 may interact with input/output devices via I/O Ports 114. Input/output devices can include, but are not limited to, a keyboard, a microphone, a pointing and selection device, cameras, video cards, displays, gaming devices, and the like. The I/O Ports 114 can include, but are not limited to, serial ports, parallel ports, and USB ports. The computing device 100 can operate in a network environment and thus may be connected to network or other remote devices via the I/O Ports 114. The networks with which the computing device 100 may interact include, but are not limited to, a local area network (LAN), a wide area network (WAN), and other networks. The I/O Ports 114 can connect to LAN technologies including, but not limited to, fiber distributed data interface (FDDI), copper distributed data interface (CDDI), Ethernet (IEEE 802.3), token ring (IEEE 802.5), wireless computer communication (IEEE 802.11), Bluetooth (IEEE 802.15.1), Zigbee (IEEE 802.15.4) and the like. Similarly, the I/O Ports 114 can connect to WAN technologies including, but not limited to, point to point links, circuit switching networks like integrated services digital networks (ISDN), packet switching networks, and digital subscriber lines (DSL). While individual network types are described, it is to be appreciated that communications via, over, or through a network may include combinations and mixtures of communications.

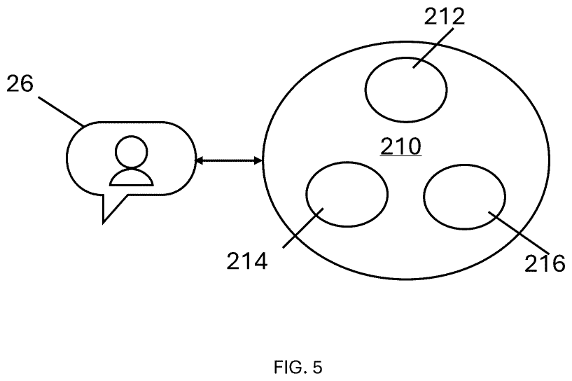

FIGS. 5-12 schematically illustrate some of the possible operations involving the virtual assistant 26 (FIG. 1). The illustrated operations are only examples of many possible operations that may be accomplished by the virtual assistance, for example using artificial intelligence.

FIG. 5 shows a learning action, where the virtual assistant 26 receives information from one or more information sources 210. Information from the information sources 210 may be used for training the virtual assistant 26, for example using a large-language model to train the virtual assistant 26. The receipt of information from the source(s) 210 may be in any of a variety of suitable forms, such as through wireless and/or networked connections.

The sources 210 may include any of a variety of information sources, and may include content focused on, or exclusively including, video game content (or video-game-related content). The sources 210 may include internet sources 212, such as from websites, forums, communication channels, or other content focused on video games; gaming sources 214, such as video game guides; and/or player-generated content 216, such as information from previous plays of games by the user 22 (FIG. 1) or other game players, to give a few nonlimiting examples. Also, game-related content may be provided by game makers. The content may be in the form of text, video, and/or sound, which all may be used in training the virtual assistant 26, providing the virtual assistant 26 a knowledge base to function as a video game expert in assisting the user 22.

In various embodiments, the virtual assistant 26 may be implemented using a modular machine learning (ML) architecture that includes both local processing on the controller and, optionally, cloud-based components for enhanced inference and training. The virtual assistant 26 may comprise several functional modules (e.g., software modules). In embodiments, the virtual assistant 26 may include a game recognition submodule, which utilizes convolutional neural networks (CNNs) and recurrent neural networks (RNNs) to identify the specific game being played as well as the level, section, or scenario within the game. This recognition can be based on either visual cues from the front-facing camera 52 or auditory cues from the microphone 56. In some embodiments, a natural language processing (NLP) submodule, based on transformer-based language models (e.g., BERT, Whisper, GPT), interprets user voice commands and determines the user's intent. A contextual strategy generator (CSG) uses a combination of reinforcement learning and supervised training on curated gameplay datasets and community-generated strategies to provide in-game guidance, tips, or suggestions for progressing through a game or overcoming specific challenges.

To facilitate adaptation and improvement over time, the virtual assistant 26 supports multiple training modes. In some embodiments, on-device training is achieved through federated learning, allowing the system to learn user-specific behavior without transmitting raw user data externally. Additionally, anonymized feature data may be transmitted to a central server for batch training of generalized models using supervised and semi-supervised learning methods. These models may then be updated periodically and downloaded to user devices. The training data used may include annotated gameplay video, synthetic game simulations, player input sequences, audio logs, and natural language command corpora.

The virtual assistant 26 may be invoked (e.g., called upon or otherwise initiated) by a predetermined sound or voice command, by detecting specific game context from video or audio input, or manually through a designated hardware button on the controller 18. Once invoked, the virtual assistant 26 captures relevant input from the microphone 56, front-facing camera 52, and control interfaces, performs context recognition, and generates output tailored to the user's gameplay state. For example, if the assistant detects that the user is repeatedly failing a section of a game, it may provide context-aware hints such as identifying hidden items or suggesting alternate strategies. In some embodiments, the assistant may autonomously activate based on analysis of gameplay data indicative of player difficulty or hesitation.

The virtual assistant 26 is further configured to improve itself over time based on user interactions. For example, the visual recognition module may refine its model based on feedback from successful or unsuccessful image-based game identification. The NLP module may adapt based on misinterpreted commands and subsequent clarifications from the user. The strategy generation system may also learn from player outcomes following its suggestions, enhancing its predictive capabilities. These learning processes can be performed locally under user consent and may employ differential privacy techniques to ensure the confidentiality of user data. In this way, the accuracy and efficiency of the virtual assistant 26 may progressively improve over iterative training to provide more insightful output to the user while reducing the usage of computing resources such as processing resources, memory resources, bandwidth, and the like.

To enable the virtual assistant 26 to recognize a specific game being played and identify contextual information such as the current level, section, or scenario, the system employs deep learning architectures, including convolutional neural networks (CNNs) for spatial feature extraction and recurrent neural networks (RNNs), such as long short-term memory (LSTM) networks, for temporal sequence analysis. When visual input is available, the image sensor or front-facing camera 52 continuously captures frames of the gaming screen or environment. Each captured frame is preprocessed-such as by resizing, normalizing, and color space transformation—and then passed through a CNN trained to identify distinguishing visual features such as graphical user interface (GUI) elements, heads-up display (HUD) layouts, character sprites, map designs, color schemes, or unique background textures. The CNN's architecture may include multiple convolutional and pooling layers, enabling hierarchical extraction of both low-level (e.g., textures, edges) and high-level (e.g., scoreboards, item icons, HUD shapes) features.

To enhance robustness, these CNN models are trained using supervised learning on large-scale datasets consisting of labeled gameplay footage (e.g., included in the information sources 210) across multiple games and game stages. During inference, the output from the CNN may represent a high-dimensional feature vector that characterizes the current visual frame. These vectors can be passed into an RNN, which evaluates the temporal sequence of frames to recognize transitions and patterns over time-such as a change in game scene or entry into a new level. This temporal processing is particularly useful for distinguishing between different stages of a game that may have similar static visual characteristics but differ in sequence or motion-based elements, such as enemy movement or level progression animations.

In parallel or as an alternative, audio input captured by the integrated microphone 56 is analyzed to extract features such as background music, sound effects, character voices, and in-game notifications. These audio signals are transformed into a time-frequency representation, such as a mel-spectrogram or MFCC (Mel-frequency cepstral coefficients), which is suitable for CNN processing. CNNs trained on these spectrogram representations can classify audio patterns associated with specific games or game states. For instance, the system may recognize a unique musical theme tied to a game's menu screen or a recurring sound effect used in a particular level or boss encounter. Furthermore, RNNs may be used in conjunction with these CNNs to analyze temporal audio patterns, such as sequence timing of sound events or progression of musical scores, to more accurately determine the phase or context within the game.

In some embodiments, the outputs from both the visual and audio recognition pipelines may be fused using a multimodal inference engine, which combines feature vectors or classification outputs to make a consolidated prediction about the game and gameplay context. This fusion enhances accuracy, particularly in scenarios where one modality (e.g., video) may be obscured or less informative. The combined result enables the Al assistant to dynamically adjust its behavior, generate relevant assistance prompts, or offer tips based on the detected game and current scenario.

FIG. 6 illustrates the virtual assistant 26 receiving information from the screen 14 and/or the speakers 16. The virtual assistant 26 may receive visual information from the screen 14 through the camera or other optical sensor 52 (FIG. 2). Aural information may be routed to the virtual assistant 26 through the controller speaker 54 (FIG. 2).

The virtual assistant 26 may be configured to interpret visual and/or aural data for any of a variety of suitable purposes. For example, the virtual assistant 26 to identify the game being played by the user 22 (FIG. 1), through visual and/or aural cues.

As another example, the virtual assistant 26 may interpret and/or store information, for example retaining in storage mapping information for possible assistance in gameplay. The virtual assistant 26 may be able to interpret and call upon in the future map information from a displayed map screen for instance. The map information may be combined with other information, to allow the virtual assistant 26 to keep track of a player character's position within the map.

As another example, the virtual assistant 26 may be configured to execute one or more inputs with respect to the game in response to receiving a verbal command from the user via the microphone 56. In embodiments, the virtual assistant 26 may parse the natural language of the verbal command using one or more natural language processing techniques (e.g., lexical analysis, syntax analysis, semantic analysis, tokenization, stemming and lemmatization, named entity recognition, topic modeling) to ascertain the action being requested by the user. In embodiments, the verbal command may specify a particular desired action in the game (e.g., equip a bow, use a weapon). Accordingly, the virtual assistant 26 may simulate the required inputs (e.g., by generating signals corresponding to button presses) in order to perform the specified action. In certain embodiments, the verbal command may specify the particular inputs that are desired (e.g., “hold down the X button,” or “Tap the Y button 4 times every second while holding down the right bumper button). Accordingly, the virtual assistant 26 may parse the verbal command to identify the desired inputs and perform them as requested. In certain embodiments, one or more actions may be registered as macros corresponding to a particular voice command. As an example, a user may register actions of approaching an enemy (e.g., forward on a first analog stick 34) while firing a ranged weapon (e.g., aligning a cursor with the enemy using a second analog stick 36 and repeatedly pressing a right trigger button 40) and subsequently switching to a melee weapon (e.g., using a first action button 38) upon reaching a threshold distance from the enemy and swinging the melee weapon (e.g., using the right trigger button 40) as a first macro of “Attack.” Accordingly, upon identifying a verbal command of “attack,” the virtual assist may execute the corresponding inputs within the game. In this way, sequences of in-game actions may be performed via the verbal commands to facilitate increased gameplay accessibility.

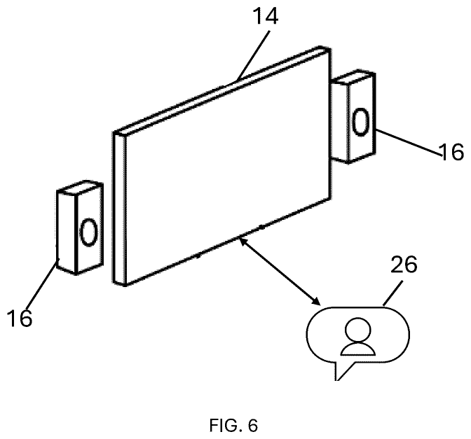

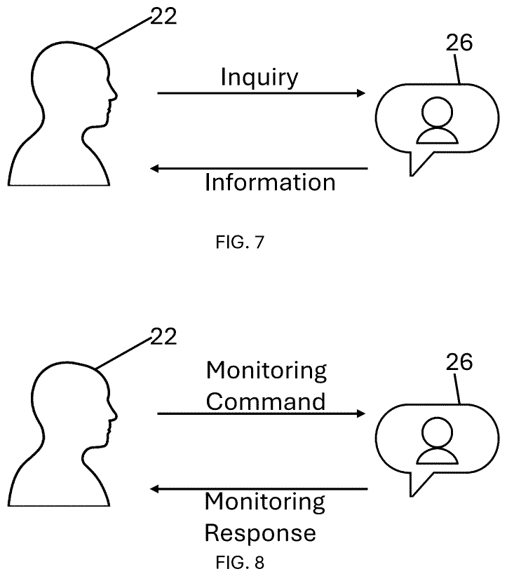

FIG. 7 schematically shows an information-providing process for the virtual assistant 26. The user 22 asks a question or otherwise makes an inquiry for information, and the virtual assistant 26 provides information in response. The inquiry may be a game-related inquiry, such as a request for information regarding the timing or location of the appearance of game characters, places, or objects, or for how to perform a given action in the game. The inquiry may be a request for hints or recommendations (advice) for gameplay, such as how to overcome a particular large or small gameplay challenge.

As an alternative, the inquiry (question or request for information) may involve background information related to the game being played. That is, the virtual assistant 26 may be configured to provide information that related to the game, but not directly to game play. For example, the virtual assistant 26 may be used by the user to obtain background information on historical figures or events that are part of a game. Other possibilities include geographical information, information regarding vehicles such as cars, and information regarding objects, such as (to give one example) weapons.

In one embodiment, the virtual assistant may be configured to provide information in the form of a summary of activities, events, characters, or factions within the game. The summary may provide a recap of past story or narrative events, character/faction biographies, and character/faction relationship information. Additionally, the summary may describe past actions taken by the player during one or more previous play sessions, together with an indication of one or more pending objectives for the player. The objectives may be goals defined by events of the game (e.g., goals to progress the story of the game) or goals tailored specifically for a particular player based on the past activities/behaviors that the player has exhibited within the game (e.g., obtaining a new item or upgrade that may be helpful prior to progressing to the next main story sequence). In embodiments, the summary may include a recap of various controls within the game (e.g., how to equip a particular weapon). In embodiments, aspects of the summary may be provided in response to verbal questions from the user. In embodiments, the summary may be automatically generated and provided to the player after a threshold time (e.g., 3 days, 1 week) has elapsed in between play sessions of the game. In this way, the memory of the player may be refreshed as to the events/activities in the game that may have been forgotten between play sessions.

It will be appreciated that a great variety of information may be requested by the user 22. In responding to the user 22 the virtual assistant 26 may draw on its training, and/or may also draw on other information, such as accessible information on the internet.

FIG. 8 illustrates a monitoring function. In the monitoring function, the user 22 makes a monitoring command to the virtual assistant 26, and the virtual assistant 26 performs the monitoring, and provides feedback to the user 22. A large variety of monitoring functions are possible. Game-related monitoring may be performed by the virtual assistant 26, at the request of the user 22. For instance, in a shooter game the user 22 may request to be informed when the user's ammunition supply in the game is low. The virtual assistant 26 may respond by monitoring the ammunition and provide a notice to the user 22 when the ammunition supply reaches (for instance) a predetermined level. The notice may be in any of a variety of forms, such as a verbal indication to the user 22 or a sound effect (played through the controller speaker 54 (FIG. 2)), or a tactile response, such with shaking of the controller 18 (FIG. 1) using an internal motor, such as a rumble motor.

As another example, the monitoring command may request monitoring of a secondary display to inform the user 22 when a game character is nearby but not in the field of vision presented by the display 14 (FIG. 1). Such monitoring can be useful in shooter games where a dangerous character may approach the user's character from behind, out of the field of view.

In an embodiment, the virtual assistant 26 may monitor the inputs (e.g., button presses) performed by the user in conjunction with visual information from a screen (e.g., collected via the front-facing camera 54) and provide feedback to the user regarding improvements that could be made to achieve a desired outcome within the game. For instance, in a fighting game, the virtual assistant 26 could monitor the inputs performed by the user in an attempt to execute a particular desired action (e.g., move or combo) as well as the screen on which the game is being displayed, identify the intended action of the user (e.g., based on the similarity of the user's input sequence to known actions defined in documentation for the game), and suggest changes (e.g., additional inputs, timing changes) to the input pattern of the user to successfully complete the desired action. As an example, in the case that a user entered inputs of “forward, forward, back, punch, forward, forward” to perform a fighting game combo but failed because of the timing of the “back” input, the virtual assistant may suggest that the user input the “back” input more quickly (e.g., within 3 frames of the previous input) in order to correctly perform the action. In this way, it may be possible to provide coaching for users to improve their proficiency at certain in-game activities.

In an embodiment, the virtual assistant 26 may monitor visual information from a screen on which the game is being displayed using the front-facing camera 54 and analyze the visual information to provide recommendations to the user to assist in-game decision-making. In embodiments, analyzing the visual information may include identifying (e.g., based on content included in the information sources 210) results or consequences of particular in-game decisions. The virtual assistant 26 may then provide an explanation to the user of the identified results or consequences. For instance, in the case that the visual information collected from the screen includes dialogue choices, the virtual assistant 26 may analyze the dialogue choices and provide an explanation to the user of how each response may affect the progression of the game (e.g., “Choosing to harm this character will let you acquire a powerful weapon, but turn this character's allies against you”). As another example, in the case that the visual information collected from the screen includes stat distributions for a character or item, the virtual assistant 26 may analyze the stat distribution and make recommendations for subsequent upgrades/stat allocations based on the in-game behavior of the user (e.g., “Based on your activities, it seems that you prefer a ranged, spell-based combat style. Allocating additional skill points to Intelligence would increase the damage of your spells.”)

It will be appreciated that the opportunities for such game-related monitoring vary widely over different types of games, and what might best serve to assist the particular user. Using the monitoring the virtual assistant 26 may serve as an extra set of eyes to aid the user 22 in game play.

Monitoring may also involve non-game-related activities. For example, the monitoring may involve reminding the user after a specified time has passed, in order to avoid the user 22 playing a game for longer than desired. As another example of non-game-related monitoring, the virtual assistant 26 may be able to monitor a security camera or camera-equipped doorbell, and provide notification when expected guests have arrived.

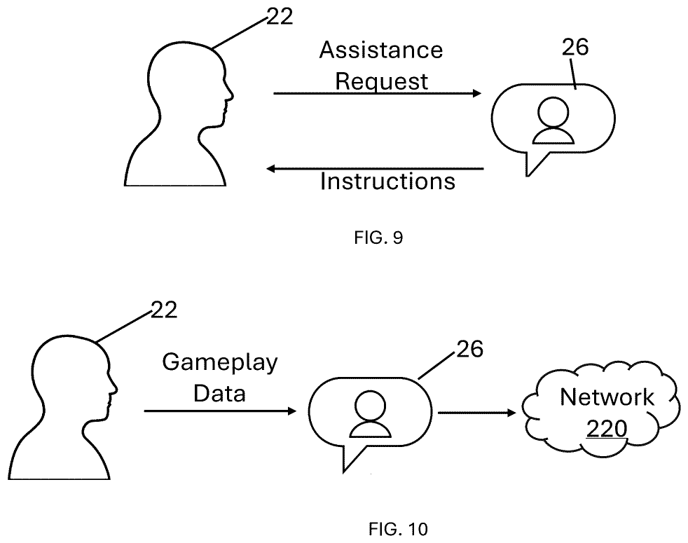

FIG. 9 shows a function where the user 22 provides a game-assistance request, and the virtual assistant 26 responds with instructions for gameplay. For example, the user 22 in a game in a maze or labyrinth (with walls and passages) may make a command for assistance in retracing their route, and the virtual assistant 26 may respond with verbal or other prompts (“turn right,” “go straight”) to accomplish the requested task.

It may be possible for the virtual assistant 26 to control to some degree the gameplay commands sent by the game controller 18 (FIG. 1) to the game console 12 (FIG. 1). For example, the virtual assistant 26 may take action to display items/locations on a game map, or to find things or aid navigation in a game menu.

It will be appreciated that the requests for game assistance may have a great variety of forms, providing assistance in any of a wide variety of game tasks. The assistance may also involve the employment of “cheat” codes or modes, that enable actions to be accomplished with the aid of the virtual assistant 26 in a manner that is not evident on the surface from the gameplay or gameplay instructions.

FIG. 10 illustrates a process by which the virtual assistant 26 records or otherwise tracks game play of the user 22. Information on the gameplay of the user 22 may be obtained from any of a variety of sources, including the camera or other image sensor 52 (FIG. 2) obtaining visual input from the screen 14 (FIG. 1), the controller speaker 54 (FIG. 2) receiving audio input, and/or the controller 18 (FIG. 1) sending direct input regarding the user's manipulation and operation of the gameplay controls 32 (FIG. 2).

The information on the user's game play may be analyzed by the virtual assistant 26 (or another connected computing device) to determine feedback that may be sent to the user 22 to provide tips/advice on game play, such as on how to improve play, for example by changing how the user 22 plays the game. This may avoid doing certain tasks (for example in certain game circumstances), changing how the user performs game actions (changing timing of a jump action, for example), or avoiding game actions that lead to undesired outcomes.

The virtual assistant 26 may develop a view of the style of gameplay employed by the user 22, and that personal style may be used in informing how the virtual assistant 26 interacts with the user 22. For example, the virtual assistant 26 may determine an overall skill level and/or a task-specific skill level of the user 22 from historical gameplay information, and may provide information, feedback, and/or recommendations in light of the determined user skill level. The skill level determinations may be game specific, or may be global, applying across different games. The determined skill level (more broadly, the user's style) for one game may be used in informing the virtual assistant 26 about the skills/style of the user in other games. The virtual assistant 26 may be configured to determine optimal (or more optimal) gameplay strategies for the user 22, and such determinations may take into account the abilities (such as skill level) of the user 22 in performing gameplay tasks.

Information on the game play of the user 22, either in raw form or in abstracted form (such as skill levels or styles) may be forwarded by the virtual assistant 26 to a network 220, where the information may be accessed by a network of virtual assistants. Through this process the experiences of multiple users, playing games on different controllers, may be used to inform a network of virtual assistants. Such gameplay information may form part of the information sources 210 (FIG. 5) used in training virtual assistants. Through this process any given virtual assistant may be trained using the game play experiences of thousands of widely separated users, enhancing the game play knowledge and expertise of the virtual assistant 26.

Other features may be based on the information gathered from a user's game play. A user may have the ability to have the virtual assistant 26 to provide tips/hints/advice to allow the user to learn to play in the style of that other user. The similarity of styles of different users, or the play levels of different users, may be compared using the game play data of the different users.

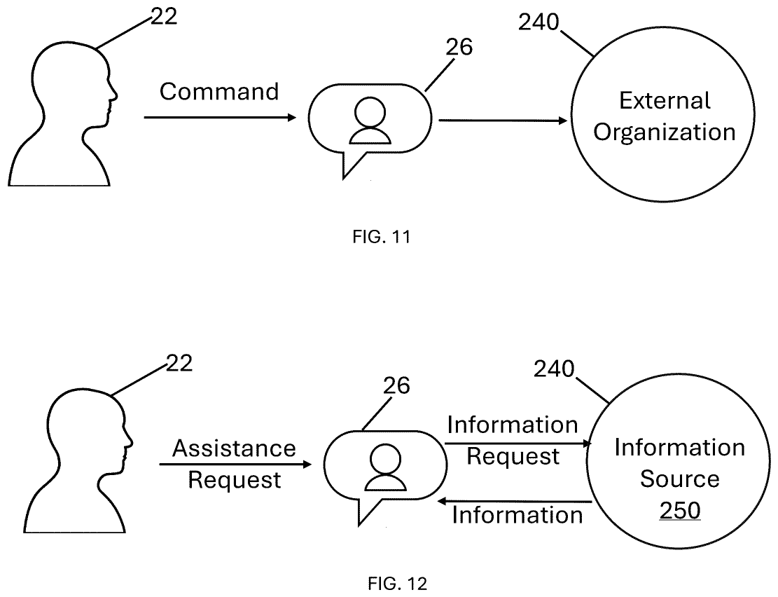

FIG. 11 shows an operation where the user 22 sends an out-of-game command to the virtual assistant 26 (such as by a natural-language voice command), and the virtual assistant 26 accomplishes the task by interacting with an external organization 240. For example, the user 22 may instruct the virtual assistant 26 to place a delivery order for food to be delivered to the user's residence. As another example, the user 22 may instruct the virtual assistant to place a phone call or send a text or email message.

FIG. 12 illustrates a feature where the user 22 requests assistance with in-game action that requires out-of-game information, and the virtual assistant 26 accesses such information from an external source 250, and performs the in-game action using the game controller 18. For example, the user 22 may instruct the virtual assistant 26 to make the user's character look like a certain celebrity. The virtual assistant 26 may then obtain information about the celebrity's appearance from the internet (an example of the external source 250), use control the game controller 18 to make appropriate commands to the game console (FIG. 1) to accomplish the desired celebrity appearance for the user's character.

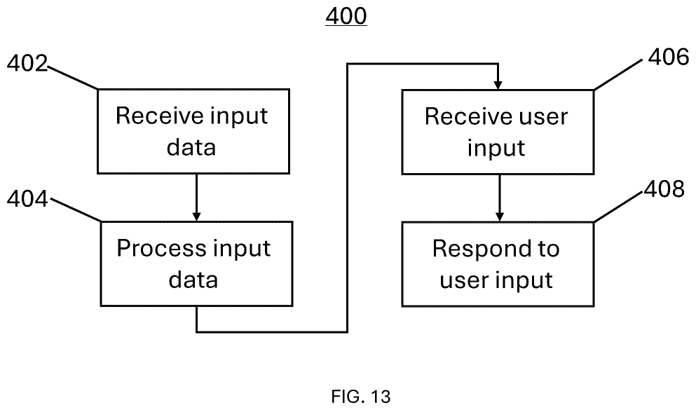

FIG. 13 is a high-level flow chart showing steps in a method 400 of using the artificial-intelligence virtual gameplay assistant 26 (FIG. 1). In step 402 input data is received, and in step 404 the data is processed to produce the artificial-intelligence virtual gameplay assistant 26. These steps may be part of the learning process described above with regard to FIG. 5.

In step 406 the virtual assistant 26 (FIG. 1) receives input from the user 22 (FIG. 1), and in step 408 the virtual assistant 26 provides a response to the user input (which may be an action initiated by the virtual assistant 26 and/or a communication to the user 22). Examples of these steps are illustrated in FIGS. 7-9, discussed above.

Although the disclosure has been shown and described with respect to a certain embodiment or embodiments, equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the disclosure. In addition, while a particular feature of the disclosure may have been described above with respect to only one or more of several illustrated embodiments, such feature may be combined with one or more other features of the other embodiments, as may be desired and advantageous for any given or particular application.

What is claimed is:

1. A video game controller, comprising:
a controller body;
at least one game control input including at least one analog stick, at least two trigger buttons, at least one action button, and at least one directional pad operatively installed to the controller body; and
at least one input device operatively installed to the controller body and configured to invoke artificial intelligence assistance.

2. The video game controller of claim 1, further comprising at least one input device for providing input to the artificial intelligence assistance.

3. The video game controller of claim 2, wherein the at least one input device includes a microphone.

4. The video game controller of claim 1, wherein the artificial intelligence assistance is configured to be invoked by a predetermined sound caught by the at least one input device.

5. The video game controller of claim 1, wherein the at least one input device includes an image sensor or camera.

6. The video game controller of claim 5, wherein the artificial intelligence assistance is configured to receive input from the image sensor or camera and to detect a specific game being played based on the input.

7. The video game controller of claim 5, wherein the artificial intelligence assistance is configured to receive input from the image sensor or camera and to detect level or section within a specific game being played based on the input.

8. The video game controller of claim 5, wherein the artificial intelligence assistance is configured to receive input from the image sensor or camera and to detect level or section within a specific game being played based on the input and to provide output corresponding to a strategy or tips for completing or exiting the level or section.

9. The video game controller of claim 5, wherein the artificial intelligence assistance is configured to receive input from the image sensor or camera and to detect a specific game being played based on the input and to provide output corresponding to the specific game.

10. The video game controller of claim 5, wherein the artificial intelligence assistance is configured to receive input from the image sensor or camera and to detect a specific game being played based on the input and to provide output corresponding to the specific game when prompted by a user's voice command.

11. The video game controller of claim 5, wherein the artificial intelligence assistance is configured to receive input from the image sensor or camera and to use the received input to train the artificial intelligence assistance.

12. The video game controller of claim 1, wherein the artificial intelligence assistance is configured to receive input and to provide output corresponding to the specific game being played including strategy or tips for succeeding in the game.

13. The video game controller of claim 1, wherein the artificial intelligence assistance is configured to receive input corresponding to the at least one game control input and use the received input to train the artificial intelligence assistance.

14. The video game controller of claim 3, wherein the artificial intelligence assistance is configured to receive game input from the microphone and to detect a specific game being played based on the game input.

15. The video game controller of claim 3, wherein the artificial intelligence assistance is configured to receive game input from the microphone and to detect level or section within a specific game being played based on the input.

16. The video game controller of claim 3, wherein the artificial intelligence assistance is configured to receive input from the microphone and to detect level or section within a specific game being played based on the input and to provide output corresponding to a strategy or tips for completing or exiting the level or section.

17. The video game controller of claim 3, wherein the artificial intelligence assistance is configured to receive input from the microphone and to detect a specific game being played based on the input and to provide output corresponding to the specific game.

18. The video game controller of claim 3, wherein the artificial intelligence assistance is configured to receive input from the microphone and to detect a specific game being played based on the input and to provide output corresponding to the specific game when prompted by a user's voice command.

19. The video game controller of claim 3, wherein the artificial intelligence assistance is configured to receive input from the microphone and to use the received input to train the artificial intelligence assistance.

20. The video game controller of claim 3, wherein the artificial intelligence assistance is configured to:
receive a user voice command via the microphone;
parse the user voice command using natural language processing techniques to identify an in-game action; and
execute inputs with respect to a specific game to perform the identified in-game action.

21. The video game controller of claim 1, further comprising at least one output device for providing output from the artificial intelligence assistance.

22. The video game controller of claim 21, wherein the at least one output device includes a speaker.

23. A method of assisting a video game controller user, the method comprising:
receiving data on video game gameplay;
processing the data to produce an artificial intelligence virtual gameplay assistant;
receiving user input from a video game user; and
using the virtual gameplay assistant to produce a response to the user input.
